(19) United States
(12) Patent Application Publication
(10) Pub. No.: US 2026/0081964 A1
(43) Pub. Date: Mar. 19, 2026

(54) TECHNIQUES FOR REDUCING THE AMOUNT OF RESOURCES USED TO STREAM LIVE EVENTS

(71) Applicant: NETFLIX, INC., Los Gatos, CA (US)

(72) Inventors: Christopher Alan NEWTON, North Richland Hills, TX (US); Xiaomei LIU, Cupertino, CA (US)

(21) Appl. No.: 18/888,975

(22) Filed: Sep. 18, 2024

(51) Int. Cl. H04L 65/80; H04N 21/24; H04N 21/84

(52) U.S. Cl. CPC H04L 65/80; H04N 21/2402; H04N 21/8402

(57) ABSTRACT

In various embodiments, an origin application responds to requests associated with streamed live events. The origin application receives a request from a device for a segment of a stream associated with a live event. The origin application determines at least one of an error condition or a time-to-live (TTL) based on a current index associated with the live event and an index associated with the segment. The origin application transmits to the device a response indicating at least one of the error condition or the TTL.

### BACKGROUND

### Field of the Various Embodiments

The various embodiments relate generally to computer science and to media streaming technology and, more specifically, to techniques for reducing the amount of resources used to stream live events.

### Description of the Related Art

In some approaches to streaming media content to user devices, a streaming pipeline is used to encode discrete portions of a media source across different sets of encoding parameters to generate segments of different streams. Each “stream” constitutes a different encoded version of the entire media source. These segments are stored in memory associated with an origin server and subsequently streamed to various user devices, on-demand, often via a content delivery network (CDN). In many conventional CDNs, edge servers are implemented at the lowest level of a server hierarchy and typically reside in the same geographical region as the user devices to which content is delivered. Each edge server usually is capable of caching the segments associated with various streams and transmitting segments to one or more user devices on behalf of an origin server.

When an edge server receives a request from a user device for a segment that is not stored in cache memory associated with the edge server, the edge server has to relay the request upstream through the CDN until the request either reaches a server that has the segment stored in cache memory or ultimately reaches the origin server. The response to the request is relayed downstream through the CDN to the edge server, and the edge server transmits the response to the user device. This type of on-demand delivery process works well when streaming pre-generated streams for static media sources, such as videos of movies. However, in the context of live events, streams are incrementally generated based on live media feeds in real-time. As a result, user devices can have difficulty determining the name of each segment and when to request each segment when streaming live event streams.

In one approach to streaming live event streams, each live event stream is associated with a segment name template, and each user device implements a clock that is synchronized with a clock implemented by the streaming pipeline. The segment name template specifies a start time, a segment duration, and a parameterized segment name that includes an index parameter. The segment name template associated with a live event stream enables a user device to compute expected availability times and names of the segments of the live event stream. To stream a live event stream, the user device repeatedly computes the expected availability time and name of the next segment, and when the clock reaches the expected availability time, the user device transmits a request specifying the name of the next segment to an edge server.

One drawback of the above approach is that, because the actual availability times can deviate from the expected availability times, a user device can end up requesting segments of a stream that have not yet been generated and/or stored in the origin server. When a user device prematurely requests a segment in this fashion, the request oftentimes is relayed upstream through the entire CDN to the origin server. The origin server then responds that the segment cannot be found, and the response is relayed downstream, back through the entire CDN, to the user device. Upon receiving the response indicating that the segment cannot be found, the user device usually re-requests the segment within a few milliseconds in an attempt to reduce the time between when some aspect of the live event occurs and when the user device displays the media content corresponding to that aspect of the live event. This process can repeat multiple times, where the user device re-requests the segment, before the segment actually becomes available and can be transmitted to the user device. This repeated process of requesting and re-requesting segments prematurely can end up unnecessarily wasting substantial amounts of time and network and processing resources.

As the foregoing illustrates, what is needed in the art are more effective techniques for streaming segments of live event streams.

### SUMMARY

One embodiment sets forth a computer-implemented method for responding to requests associated with streamed live events. The method includes receiving a first request from a first device for a first segment of a first stream associated with a live event; determining at least one of an error condition or a first time-to-live (TTL) based on a current index associated with the live event and a first index associated with the first segment; and transmitting to the first device a first response indicating at least one of the error condition or the first TTL.

At least one technical advantage of the disclosed techniques relative to the prior art is that, with the disclosed techniques, the number of re-requests for the segments of a live event stream can be reduced. In that regard, with the disclosed techniques, an origin server can include, in a response to a premature request for a segment of a stream, a time-to-live (TTL) indication that reflects an estimated availability time for that segment. A CDN automatically caches the response for the period of time specified via the TTL, and any user devices that prematurely request the segment can use the TTL to delay re-requesting the segment until the estimated availability time. Because the disclosed techniques can reduce the number of re-requests for segments, the amount of network and processing resources used to stream live events can be reduced relative to what is typically required using prior art techniques. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the streaming-aware response engine of FIG. 1, according to various embodiments; and

FIGS. 3A-3B set forth a flow diagram of method steps for responding to a request associated with a streamed live event, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

Some media service providers stream a live event in real-time to a variety of different user devices via a streaming pipeline, an origin server, and a CDN. The streaming pipeline encodes live media feeds across a variety of different encoding parameters to generate segments of different streams. As each segment is generated, the origin server stores the segment in an associated memory. Throughout a live event, the origin server delivers segments of streams associated with the live event to various client devices, on-demand, via the CDN. The CDN includes a server hierarchy, where each server can selectively cache segments and other data associated with streaming live events.

When an “edge” server that is implemented at the lowest level of the server hierarchy receives a request from a user device for a segment, the request is relayed upstream through the CDN until the request either reaches a server that has the segment stored in cache memory or ultimately reaches the origin server. A response to the request is relayed downstream through the CDN to the edge server, and the edge server transmits the response to the user device. This type of on-demand delivery process works well when streaming pre-generated streams for static media sources, such as videos of movies. However, in the context of live events, streams are incrementally generated based on live media feeds in real-time. As a result, user devices can have difficulty determining the name of each segment and when to request each segment when streaming live event streams.

In one conventional approach to streaming live event streams, each live event stream is associated with a segment name template, and each user device implements a clock that is synchronized with a clock implemented by the streaming pipeline. The segment name template associated with a live event stream enables a user device to compute expected availability times and names of the segments of the live event stream. To stream a live event stream, the user device repeatedly computes the expected availability time and name of the next segment, and when the clock reaches the expected availability time, the user device transmits a request specifying the name of the next segment to an edge server.

One drawback of the above approach is that, because the actual availability times can deviate from the expected availability times, a user device can end up requesting segments of a stream that have not yet been generated and/or stored by the origin server. When a user device prematurely requests a segment in this fashion, the request oftentimes is relayed upstream through the entire CDN to the origin server. The origin server then responds that the segment cannot be found, and the response is relayed downstream, back through the entire CDN, to the user device. Upon receiving the response indicating that the segment cannot be found, the user device usually re-requests the segment within a few milliseconds in an attempt to reduce the time between when some aspect of the live event occurs and when the user device displays the media content corresponding to that aspect of the live event. This process can repeat multiple times, where the user device re-requests the segment, before the segment actually becomes available and can be transmitted to the user device. This repeated process of requesting and re-requesting segments prematurely can end up unnecessarily wasting substantial amounts of time and network and processing resources.

With the disclosed techniques, however, the origin server can enhance responses to unsuccessful requests for segments associated with live events with re-request guidance. The origin server determines the re-request guidance for an unsuccessful request based on an index associated with the requested segment, a current index associated with the live event, and optionally a segment duration associated with the live event. The index indicates a position of the request segment along a playback timeline associated with the live event. The current index indicates a position of the most recent segment associated with the live event along the playback timeline.

The re-request guidance specifies an error condition and optionally a time-to-live (TTL). Some examples of re-request guidance include:
an error condition indicating that a service is unavailable and a rejection TTL indicating a new time at which to re-request the requested segment.
an error condition indicating that the requested segment cannot be found and a retry TTL that reflects an estimated availability time-based
an error condition indicating that the requested segment is unavailable and that this condition is likely to be permanent.

At least one technical advantage of the disclosed techniques relative to the prior art is that, with the disclosed techniques, the number of re-requests for the segments of a live event stream can be reduced. In particular, with the disclosed techniques, the origin server can indicate, in a response to a premature request for a segment of a stream, a retry TTL that reflects an estimated availability time for that segment. A CDN automatically caches the response for the period of time specified via the retry TTL, and any user devices that prematurely request the segment can use the retry TTL to delay re-requesting the segment until the estimated availability time. And, for the period of time specified via the retry TTL, any repeated re-requests issued by user devices that do not honor the retry TTL can be satisfied at an edge server from the cached response without relaying the re-request upstream, back through the entire CDN, to the origin server. Further, with the disclosed techniques, the origin server can indicate, in a response to a request for an unavailable segment of a stream, an error condition indicating that the requested segment is unavailable and that this condition is likely to be permanent. Any user devices that request the unavailable segment can use the error condition to avoid futilely re-requesting the unavailable segment. Because the disclosed techniques can reduce the number of re-requests for segments, the amount of network and processing resources used to stream live events can be reduced relative to what is typically required using prior art techniques. These technical advantages provide one or more technological advancements over prior art approaches.

### System Overview

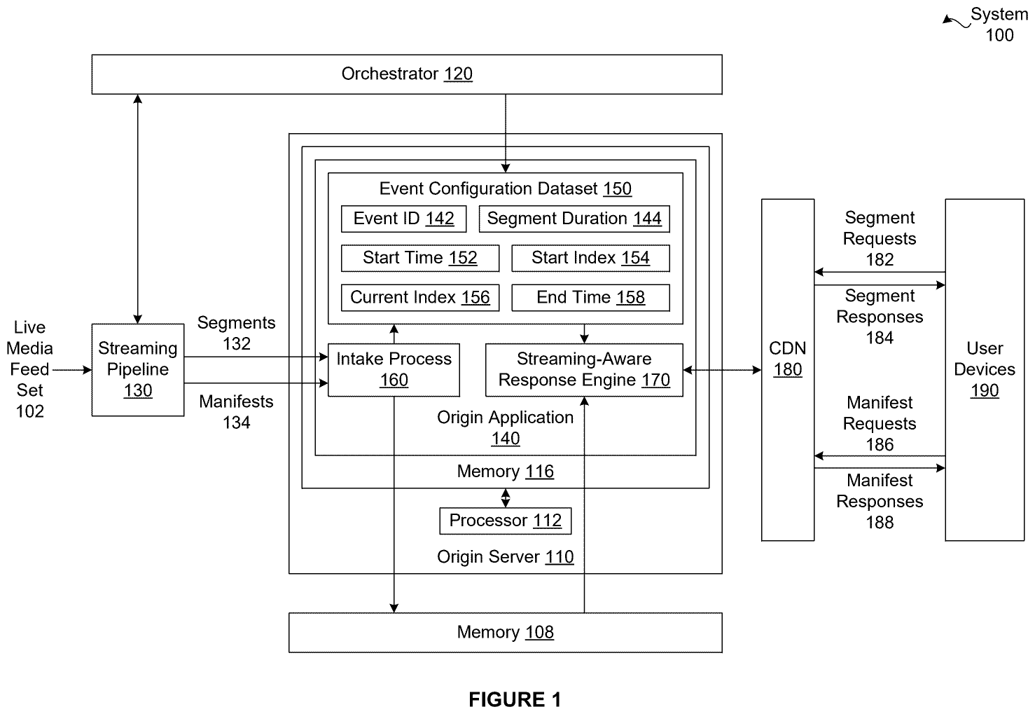

FIG. 1 is a conceptual illustration of a system 100 configured to implement one or more aspects of the various embodiments. As shown, in some embodiments, the system 100 includes, without limitation, a streaming pipeline 130, an origin server 110, a memory 108, a content delivery network (CDN) 180, user devices 190, and an orchestrator 120.

In some other embodiments, the system 100 can omit the memory 108, the CDN 180, the orchestrator 120, or any combination thereof. In the same or other embodiments, the system 100 can further include one or more other streaming pipelines, one or more other origin servers, one or more other memories, one or more other CDNs, or any combination thereof.

For instance, in some embodiments, the system 100 can include multiple instances of a streaming pipeline that are configured as redundant streaming pipelines, and the techniques described herein are modified accordingly. In the same or other embodiments, the system 100 can include multiple origin servers and/or multiple CDNs and the techniques described herein are modified accordingly.

Any number of the components of the system 100 can be distributed across multiple geographic locations. Any number of the components of the system 100 can be implemented in one or more cloud computing environments (e.g., encapsulated shared resources, software, data), implemented as part of any other distributed computing environment, implemented in a stand-alone fashion, or any combination thereof.

For explanatory purposes, the functionality of the streaming pipeline 130, the origin server 110, the memory 108, the CDN 180, the user devices 190, and the orchestrator 120 are described herein in the context of streaming a live event based on a live media feed set 102. The live media feed set 102 includes, without limitation, one or more live media feeds that each relay media content associated with a different source (e.g., different cameras, different microphones). Some examples of live events are a live sporting event, a live television show, a live performance, a live speech, and a live meeting. Some examples of different types of media content are video, audio, and captions.

As shown, the streaming pipeline 130 periodically generates segments 132 and manifests 134 throughout the live event based on the live media feed set 102. As described in greater detail below, the segments 132 are segments of one or more streams associated with the live event, and the manifests 134 describe portions (including none or all) of one or more streams associated with the live event. In this fashion, the streaming pipeline 130 incrementally generates and describes one or more streams associated with the live event in real-time during the live event.

As referred to herein, a “stream” is an encoded version of any type of media data. Each stream that is derived from a live media feed includes, without limitation, a sequence of one or more discrete, time-based segments that correspond (in a playback timeline) to a sequence of one or more discrete portions of the live media feed. For explanatory purposes, a “segment” as used herein refers to a segment of a stream. In many embodiments, each segment of each stream associated with the live event has the same duration (e.g., four seconds) that is referred to herein as a “segment duration.”

Each portion of a live media feed corresponds to a different index, where the index indicates the position of the portion of the live media feed within the playback timeline relative to the other portions of the live media feed. For instance, in some embodiments, the portion of the live event feed that starts at the beginning of an associated live event corresponds to an index of 1, the next portion of the live media feed corresponds to an index of 2. etc.

Each segment of each stream derived from a given portion of a given live media feed indicates the index of that same portion of that same live media feed. Importantly, segments of different streams derived from one or more live media feeds associated with the same live event that indicate the same index correspond to the same time interval in the same playback timeline.

The manifests 134 enable the user devices 190 to stream the live event via the CDN 180. More precisely, each of the manifests 134 describes any portions (including none or all) of each of one or more streams that are generated in real-time during the live event, where each portion of each stream corresponds to the same interval in the playback timeline of the live event. In some embodiments, each of the manifests 134 indirectly or directly indicates the segments of the described portion(s) of stream(s) and provides any number and/or types of playback instructions. The playback instructions can be used by the user devices 190 to determine when and how to request segments from the CDN 180.

In some embodiments, the streaming pipeline 130 generates a “primary” manifest for the live event prior to or coincident with the start of the live event. The primary manifest describes one or more streams that are generated in real-time during the live event and optionally any amount and/or types of other metadata that describes any number of aspects of the stream(s) and/or segments of the streams. In some embodiments, the primary manifest includes a segment name template for each stream associated with the live event. The segment name template specifies a start time, a segment duration, and a parameterized segment name that includes an index parameter. The segment name template associated with a stream enables a user to compute expected availability times and names of the segments of the stream.

A parameterized segment name for a stream can encapsulate a naming convention for the segments of the stream based on one or more parameters in any technically feasible fashion. In some embodiments, a parameterized segment name includes, without limitation, an index parameter that is replaced with an index to generate a name of a corresponding segment. As used herein, a name of a segment refers to any type of identifier for the segment. For instance, a name of a segment can be any portion (including all) of a Universal Resource Locator (URL). Notably, a primary manifest that includes a parameterized segment name for a stream enables any number and/or types of user devices to determine names of segments of the stream irrespective of whether the segments have actually been generated.

In some embodiments, the streaming pipeline 130 generates and/or regenerates window manifest(s) and/or event manifest(s) throughout the live event. A window manifest generated or regenerated by the streaming pipeline 130 at a particular point-in-time indicates segments of one or more streams associated with the live event that have been generated by the streaming pipeline 130 within a sliding time window that ends at that point-in-time. By contrast, an event manifest generated or regenerated by the streaming pipeline 130 at a particular point-in-time indicates all segments of one or more streams associated with the live event that have been generated by the streaming pipeline 130 at that point-in-time.

For instance, if the sliding time window has a fixed duration of thirty seconds, then a window manifest generated by the streaming pipeline 130 at a particular point-in-time indicates segments of one or more streams associated with the live event that have been generated by the streaming pipeline 130 within the last thirty seconds. By contrast, an event manifest generated by the streaming pipeline 130 at the same point-in-time indicates all segments of one or more streams associated with the live event that have been generated by the streaming pipeline 130 thus-far.

Notably, if a window manifest generated by the streaming pipeline 130 at a particular point-in-time describes a first portion of a stream associated with the live event, then an event manifest generated by the streaming pipeline 130 at a later point-in-time describes the first portion of the stream and at least a second portion of the stream. And an event manifest generated by the streaming pipeline 130 at or after the end of the live event describes the entire stream. More specifically, an event manifest generated by the streaming pipeline 130 at or after the end of the live event indicates segments of the stream that collectively span the entire playback timeline of the live event.

In operation, as the streaming pipeline 130 receives the live media feed set 102, the streaming pipeline 130 performs distribution encoding on the live media feed set 102 to generate the segments 132. In that regard, the streaming pipeline 130 encodes each live media feed in the live media feed set 102 in real-time across one or more sets of encoding parameters to incrementally generate one or more streams having different characteristics. For instance, in some embodiments, the streaming pipeline 130 encodes video content included in a live video feed in the live media feed set 102 across multiple sets of encoding parameters to generate video streams having different combinations of resolutions and bitrates.

In some embodiments, the streaming pipeline 130 independently encodes each portion of a live media feed to ensure that each corresponding segment can be decoded independently of any other segments. Ensuring that each segment can be independently decoded enables the user devices 190 to switch between streams generated based on the same live media feed at segment boundaries during playback.

The streaming pipeline 130 performs any number and/or types of packaging operations on the segments 132 to prepare the segments 132 for delivery to the user devices 190 via the CDN 180. Some examples of packaging operations include encrypting segments, applying digital rights management (DRM) to segments, and reformatting segments.

As the streaming pipeline 130 generates the segments 132, the streaming pipeline 130 generates and/or regenerates any number of window manifests and/or any number of event manifests. The streaming pipeline 130 can generate and regenerate window manifests and/or event manifests in any technically feasible fashion and at any cadence. In some embodiments, the streaming pipeline 130 periodically (e.g., every five seconds) throughout the live event generates or regenerates, without limitation, a window manifest and an event manifest based on the segments 132.

As shown, the streaming pipeline 130 relays the segments 132 and the manifests 134 to the origin server 110 in real-time. More specifically, as the streaming pipeline 130 generates new segments associated with the live event and new manifests associated with the live event, the streaming pipeline 130 transmits the new segments and the new manifests to the origin server 110.

In some other embodiments, the streaming pipeline 130 can relay the segments 132 and the manifests 134 to any number of additional origin servers. In the same or other embodiments, any number of additional streaming pipelines can each relay a different version of the segments 132 to the origin server 110 and optionally any number of additional origin servers. The techniques described herein are modified accordingly.

As shown, the origin server 110 includes, without limitation, a processor 112 and a memory 116. In some other embodiments, each of the origin server 110 and optionally any number of additional origin servers can include any number of other processors and/or any number of other memories in any combination.

The processor 112 can be any instruction execution system, apparatus, or device capable of executing instructions. For example, the processor 112 could comprise a central processing unit, a graphics processing unit, a controller, a micro-controller, a state machine, or any combination thereof. The memory 116 of the origin server 110 stores content, such as software applications and data, for use by the processor 112 of the origin server 110.

The memory 116 can be one or more of a readily available memory, such as random-access memory, read only memory, floppy disk, hard disk, or any other form of digital storage, local or remote. In some embodiments, a storage (not shown) may supplement or replace the memory 116. The storage may include any number and type of external memories that are accessible to the processor 112 of the origin server 110. For example, and without limitation, the storage can include a Secure Digital Card, an external Flash memory, a portable compact disc read-only memory, an optical storage device, a magnetic storage device, or any suitable combination of the foregoing.

In some embodiments, the origin server 110 is a compute instance. Although not shown, in the same or other embodiments, any number of other compute instances can be configured to implement the streaming pipeline 130, the CDN 180, the user devices 190, the orchestrator 120, or any combination thereof.

In general, each compute instance (including the origin server 110) is configured to implement one or more software applications. For explanatory purposes only, each software application is described as residing in the memory of a single compute instance and executing on a processor of the same compute instance. However, in some embodiments, the functionality of each software application can be distributed across any number of other software applications that reside in the memories of any number of compute instances and execute on the processors of any number of compute instances in any combination. Further, the functionality of any number of software applications can be consolidated into a single software application.

In particular, the origin server 110 is configured to store in the memory 108 received segments and received manifests associated with any number of live events for on-demand delivery to any number of the user devices 190 via the CDN 180. The received segments and the received manifests include, without limitation, the segments 132 and the manifests 134. The memory 108 can include any number and/or types of memory that are accessible to the origin server 110. In some embodiments, the memory 108 is cloud storage.

In some alternate embodiments, the memory 108 can be at least a portion of at least one memory that is included in the memory 116, any number and/or types of other internal memories that are available to the origin server 110, any number and/or types of external memories (e.g., storage) that are available to the origin server 110, any amount of cloud storage, or any combination thereof.

The CDN 180 delivers segments (including the segments 132) and manifests (including the manifests 134) associated with any number of live events on behalf of the origin server 110 to any number of the user devices 190 on-demand. Although not shown, the CDN 180 includes any number of servers that are arranged in a server hierarchy, where each server is usually capable of selectively caching resources and optionally associated items. In particular, each server in the server hierarchy is capable of selectively caching segments of streams associated with streamed live events, manifests associated with streamed live events, and optionally portions (including all) of responses to requests associated with streamed live events. As used herein a “streamed live event” can refer to any live event that is streamed to any number of the user devices 190 on-demand via the origin server 110.

In some embodiments, the CDN 180 includes any number of edge servers (not shown) that are implemented at the lowest level of the server hierarchy and any number of caching servers (not shown) that are implemented at higher levels of the server hierarchy. The edge servers receive requests from and transmit responses to the user devices 190 on behalf of the origin server 110. A subset of the caching servers that are implemented at the highest level of the server hierarchy transmit requests to and receive response from the origin server 110 on behalf of the user device 190.

In general, for each request transmitted from a user device to the CDN 180, if the CDN 180 can respond to the request based on resources and/or associated items stored in a cache memory, then a “cache hit” occurs, and the CDN 180 transmits a corresponding response to the user device. Otherwise, a “cache miss” occurs and the CDN 180 relays the request to the origin server 110.

Each of the user devices 190 can be any type of device that is capable of communicating with the CDN 180 to stream live events. More specifically, each of the user devices 190 is capable of requesting, decoding, and playing back segments of streams associated with a live event based on manifests associated with the live event. Some examples of user devices 190 include, without limitation, desktop computers, laptops, smartphones, tablets, and set-top boxes.

As shown, to stream the live event in real-time, any number of the user devices 190 transmit segment requests 182 and manifest requests 186 to the CDN 180 and, in response, receive segment responses 184 and manifest responses 188 from the CDN 180. Each of the segment requests 182 is a request or a re-request for a segment of a stream associated with the live event. Each of the manifest requests 186 is a request or a re-request for a manifest associated with the live event. Each of the segment responses 184 is a response corresponding to one of the segment requests 182 that either includes a requested segment or indicates an error (e.g., indicating that the requested segment was not found). Each of the manifest responses 188 is a response corresponding to one of the manifest requests 186 that either includes a requested manifest or indicates an error (e.g., indicating that the requested manifest was not found).

As described previously herein, in one conventional approach to streaming a live event, a conventional endpoint application executing on a user device implements a clock that is synchronized with a clock implemented by the streaming pipeline 130. The conventional endpoint application repeatedly computes an expected availability time and name of a next segment based on a segment name template associated with the stream. Throughout the live event, the conventional endpoint application repeatedly computes the expected availability time and name of the next segment, and when the clock reaches the expected availability time, the user device transmits a request specifying the name of the next segment to an edge server included in the CDN 180.

One drawback of the above approach is that, because the actual availability times can deviate from the expected availability times, a conventional endpoint application can end up requesting segments of a stream that have not yet been generated and/or stored in the memory 108. When a conventional endpoint application prematurely requests a segment in this fashion, oftentimes the request is relayed upstream through the CDN 180 to the origin server 110. In response, a conventional origin application executing on the origin server responds that the segment cannot be found, and the response is relayed downstream through the CDN 180 to the user device. This request/response process is often repeated every few milliseconds until the segment actually becomes available and can be transmitted to the user device. This repeated process of requesting and requesting segments prematurely can end up unnecessarily wasting substantial amounts of time and network and processing resources.

Another drawback of the above approach is that in order to reduce the likelihood of prematurely requesting segments of a stream associated with a live event, some user devices intentionally delay requesting each segment by a few seconds from the expected availability time. As a result, the overall latency of the live streaming experience is increased.

### Enhancing Responses to Unsuccessful Requests

To address the above problems, the origin server 110 includes, without limitation, an origin application 140 that enhances with re-request guidance responses to unsuccessful requests for segments and manifests associated with the live event. Notably, the re-request guidance can be used by the CDN 180 and/or the user devices 190 to reduce the number of futile re-requests. More specifically, the origin application 140 indicates one of multiple error conditions and optionally a time-to-live (TTL) in each response to an unsuccessful request for a segment or a manifest associated with the live event.

Each of the error conditions that the origin application 140 can indicate in a response corresponds to a different reason for not fulfilling a corresponding request. For instance, the origin application 140 can generate a response indicating that a requested resource cannot be found (e.g., the corresponding unsuccessful request is premature), the requested resource is unavailable, or the origin server 110 is temporarily overloaded. Advantageously, if a response indicates that a requested resource is unavailable, then the user devices 190 can avoid transmitting to the CDN 180 futile re-requests for that requested resource.

In general, a TTL indicates an expiration date for an associated response, an associated resource (e.g., a segment, a manifest), etc. In the context of caching, a TTL indicates an amount of time during which an associated response and/or an associated resource can be cached by the requester (e.g., the CDN 180). Notably, any direct or indirect requester, such as any of the user devices 190, can use a TTL associated with an unsuccessful request for a resource to delay transmitting a re-request for the resource until an expiration time indicated by that TTL. For explanatory purposes, a TTL is also referred to herein as a “TTL indication.”

As shown, in some embodiments, the system 100 includes the orchestrator 120 that facilitates streaming the live event and optionally any number of other live events. In particular, the orchestrator 120 determines any amount and or type of metadata associated with publishing the live event. In some embodiments, the metadata specifies timing of the live event, one or more properties of segments of streams associated with the live event, and optionally any amount and/or types of other metadata that is relevant to streaming the live event. Notably, the metadata enables the origin application 140 to determine estimated arrival times for segments associated with the live event and detect any number and/or types of errors (e.g., timing discontinuities, late arrival times, missing segments) associated with streaming the live event during the live event.

The orchestrator 120 can transmit any amount of metadata associated with publishing to the live event to the streaming pipeline 130 and/or the origin application 140 prior to the start of the live event, during the live event, after the end of the live event, or any combination thereof. For instance, in some embodiments, the orchestrator 120 determines a segment duration 144 for the live event prior to the start of the live event and transmits the segment duration 144 to the streaming pipeline 130 and the origin application 140.

In the same or other embodiments, the orchestrator 120 transmits to the origin application 140 an end marker (not shown) when the orchestrator 120 detects the end of the live event. In response to receiving the end marker, the origin application 140 sets an end time 158 to reflect a current time as per a clock (not shown) that is implemented by the origin application 140 and is synchronized with a clock implemented by the streaming pipeline 130. For explanatory purposes, the clock that is implemented by the origin application 140 and synchronized with a clock implemented by the streaming pipeline 130 is also referred to herein as an “origin clock.”

The orchestrator 120 can determine metadata associated with publishing the live event in any technically feasible fashion. For instance, in some embodiments, the orchestrator 120 interacts with one or more users via a graphical user interface (GUI) or any other type of user interface to determine the segment duration 144. In the same or other embodiments, the orchestrator 120 can interact with and/or monitor the outputs of any number and/or types of software applications (e.g., any number of software applications included in the streaming pipeline 130) to detect the end of the live event.

As shown, the origin application 140 resides in the memory 116 of the origin server 110 and executes on the processor 112 of the origin server 110. As described previously herein, the origin application 140 implements an origin clock (not shown). The origin application 140 includes, without limitation, an event configuration dataset 150, an intake process 160, and a streaming-aware response engine 170.

The event configuration dataset 150 includes any amount and/or types of metadata associated with the live event, including any amount of publishing metadata received from the orchestrator 120. In some other embodiments, the origin application 140 includes a different event configuration dataset for each of any number of live events.

In some embodiments, the event configuration dataset 150 includes, without limitation, an event identifier (ID) 142, the segment duration 144, a start time 152, a start index 154, a current index 156, and an end time 158. The event ID 142 identifies the live event in any technically feasible fashion. As described previously herein, the segment duration 144 specifies a duration of each segment associated with the live event. The origin application 140 receives the segment duration 144 from the orchestrator 120 prior to the start of the live event. The event ID 142 and the end time 158 are received from the orchestrator 120. The start time 152, the start index 154, and the current index 156 are determined based on segments received from the streaming pipeline 130.

When streaming of the live event starts, the origin application 140 sets the start time 152 for the live event equal to a current time as per the origin clock, determines the start index 154, and sets the current index 156 equal to the start index 154. Each initial segment of each stream associated with the live event indicates the start index 154. The origin application 140 can determine that streaming of the live event has started in any technically feasible fashion. For instance, in some embodiments, the origin application 140 determines that streaming of the live event has started upon receiving from the streaming pipeline 130 an initial segment of any stream associated with the live event.

As the origin application 140 receives the segments 132 from the streaming pipeline 130, the origin application 140 updates the current index 156 to reflect the index associated with (i.e., indicated by) each segment that corresponds to a most recent interval in a playback timeline of the live event. For instance, in some embodiments, if the origin application 140 receives a segment associated with the live event that indicates an index that is greater than the current index 156, then the origin application 140 sets the current index 156 equal to that index. Accordingly, when the origin application 140 receives a last segment of any stream associated with the live event, the origin application 140 sets the current index equal to the index associated with that last segment.

When streaming of the live event ends, the origin application 140 determines the end time 158 for the live event. The origin application 140 can determine that streaming of the live event has ended in any technically feasible fashion. For instance in some embodiments, the origin application 140 determines that streaming of the live event has ended based on an end marker received from the orchestrator 120. In some other embodiments, the origin application 140 determines that streaming of the live event has ended based on an amount of time that has elapsed since the origin application 140 has received from the streaming pipeline 130 any new segments associated with the live event.

Prior to the start of the live event, the origin application 140 launches the intake process 160. Throughout the live event, the intake process 160 receives from the streaming pipeline 130 and stores in the memory 108 the segments 132 and the manifests 134. More precisely, as the intake process 160 receives from the streaming pipeline 130 each segment included in the segments 132, the intake process 160 stores the received segment in the memory 108. And as the intake process 160 receives from the streaming pipeline 130 each manifest included in the manifests 134, the intake process 160 stores the received manifest in the memory 108.

In general, when the streaming-aware response engine 170 receives a request associated with any number of live event streams from any device (e.g., a server included in the CDN 180, one of the user devices 190), the streaming-aware response engine 170 generates and transmits to the requesting device a response to the request. More precisely, in some embodiments, the streaming-aware response engine 170 can receive requests from any number of servers included in the CDN 180. In some alternate embodiments, the streaming-aware response engine 170 can receive any number of requests from any number of servers included in the CDN 180 and any number of requests directly from any number of user devices.

As shown, throughout the live event, the CDN 180 relays any number of the segment requests 182 and any number of the manifest requests 186 from the user devices 190 to the streaming-aware response engine 170. Upon receiving each segment request, the streaming-aware response engine 170 generates and transmits to the CDN 180 a corresponding segment response. Upon receiving each manifest request, the streaming-aware response engine 170 generates and transmits to the CDN 180 a corresponding manifest response.

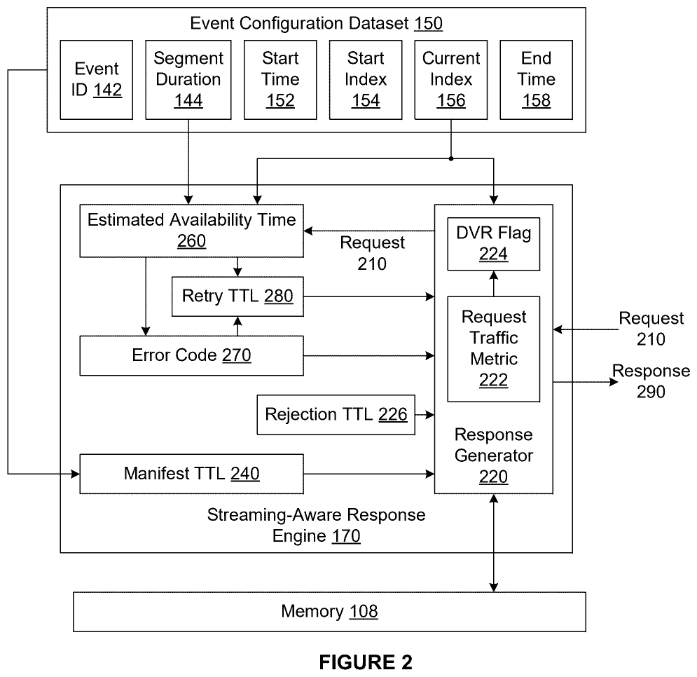

As described in greater detail below in conjunction with FIG. 2, in some embodiments, upon receiving from a device a segment request associated with the live event, the streaming-aware response engine 170 determines whether to reject the segment request. More specifically, if the origin server 110 is overloaded and the segment request is a Digital Video Recording (DVR) request, then the streaming-aware response engine 170 rejects the segment request.

As used herein, a “DVR request” refers to a request for a segment having an index that precedes the current index 156 with respect to the playback timeline associated with the live event by more than a DVR threshold. A DVR request can be a request for a video segment, an audio segment, a caption segment, or any other type of media segment. A DVR request is typically issued by a user device to seek back along the playback timeline of a live event to enable a user to pause, rewind, replay, or any combination when playing back a stream associated with the live event. Advantageously, rejecting DVR requests when the origin server 110 is overloaded effectively prioritizes segment requests that are associated with real-time viewing of any number of live events, and can therefore improve the live streaming experience for any number of users

If the streaming-aware response engine 170 elects to reject the segment request, then the streaming-aware response engine 170 transmits to the requesting device a response indicating both that a service is unavailable and a rejection TTL (not shown in FIG. 1). The rejection TTL indicates a new time to re-request the requested segment. Advantageously, as persons skilled in the art will recognize, indicating the rejection TTL in the response decreases the likelihood of a retry storm that increases pressure on the already overloaded origin server 110.

If, however, the streaming-aware response engine 170 does not elect to reject the segment request, then the streaming-aware response engine 170 determines whether the requested segment is expected to be stored in the memory 108 based on an index associated with the requested segment. In some embodiments, to determine whether the requested segment is expected to be stored in the memory 108, the streaming-aware response engine 170 compares the index associated with the requested segment to a range of indices that starts at the start index 154 and end at the current index 156.

If the index associated with the requested segment is within the range of indices, then the streaming-aware response engine 170 attempts to retrieve the requested segment from the memory 108. If the streaming-aware response engine 170 successfully retrieves the requested segment from the memory 108, then the streaming-aware response engine 170 transmits to the requesting device a response that includes the requested segment and optionally indicates that the corresponding request succeeded.

If, however, the streaming-aware response engine 170 does not elect to reject the segment request and fails to retrieve the requested segment from the memory 108, then the streaming-aware response engine computes an estimated availability time (not shown in FIG. 1) for the requested segment. As shown, the streaming-aware response engine 170 computes the estimated availability time based on the segment duration 144, the current index 156, and an index associated with the requested segment.

As described in greater detail below in conjunction with FIG. 2, the streaming-aware response engine 170 determines an error condition and optionally a retry TTL (not shown in FIG. 1) based on the estimated availability time for the requested segment. The streaming-aware response engine 170 generates and transmits to the requesting device a response specifying at least one of the error condition and the retry TTL. Advantageously, indicating a retry TTL that reflects the estimated availability time in the response increases the likelihood that the segment is actually available when the streaming-aware response engine 170 receives a re-request for the requested segment.

As described in greater detail below in conjunction with FIG. 2, if the streaming-aware response engine 170 does not elect to reject the segment request and the index associated with the requested segment is higher than the current index 156, then the streaming-aware response engine 170 computes an estimated availability time and a retry TTL. The streaming-aware response engine 170 generates and transmits to the requesting device a response indicating that the requested segment is not found and specifying the retry TTL.

If the streaming-aware response engine 170 does not elect to reject the segment request and the index associated with the requested segment is lower than the start index 154, then the streaming-aware response engine 170 transmits to the requesting device a response indicating that the requested segment is unavailable and that this condition is likely to be permanent.

In some embodiments, upon receiving from a device a manifest request associated with the live event, the streaming-aware response engine 170 determines a manifest TTL (not shown in FIG. 1) based on whether streaming of the live event is on-going. If streaming of the live event is on-going, then the streaming-aware response engine 170 sets the manifest TTL to a relatively short value (e.g., half the segment duration 144). Otherwise, the streaming-aware response engine 170 sets the manifest TTL to a relatively long value (e.g., seven days).

The streaming-aware response engine 170 attempts to retrieve the requested manifest from the memory 108. If the streaming-aware response engine 170 successfully retrieves the requested manifest from the memory 108, then the streaming-aware response engine 170 transmits to the requesting device a response that includes the manifest, indicates the manifest TTL, and optionally indicates that the corresponding request succeeded. If the streaming-aware response engine 170 fails to retrieve the manifest from the memory 108, then the streaming-aware response engine 170 transmits to the requesting device a response indicating an error condition (e.g., the manifest cannot be found) and optionally indicating a relatively short TTL.

Advantageously, specifying the manifest TTL in each successful manifest response enables the CDN 180 to more effectively cache manifests relative to prior art techniques that do not provide TTL indications in successful manifest responses. In particular, as persons skilled in the art will recognize, setting the manifest TTL to a relatively long value after the live event has ended and therefore after a final version of an event manifest is generated can increase the efficiency of the CDN 180.

As described previously herein, unlike prior art techniques, the streaming-aware response engine 170 can provide effective retry and/or caching guidance via segment responses and manifest responses associated with a live event based, at least in part, on a current index associated with the live event. As a result, the streaming-aware response engine 170 can reduce the number of re-requests for segments and manifests. Therefore the amount of network and processing resources used to stream live events can be reduced relative to what is required using prior art techniques.

In some alternate embodiments, to provide additional guidance, the streaming-aware response engine 170 can propagate up-to-date versions of any number and/or types of pieces of versioned metadata associated with the live event from the orchestrator 120 to the CDN 180 and/or the user devices 190 via each response associated with the live event. As used herein, a piece of versioned metadata data refers to a piece of metadata that is associated with a version identifier in any technically feasible fashion.

Throughout any number of live events, the streaming-aware response engine 170 receives any number and/or types of pieces of versioned metadata from the orchestrator 120. The streaming-aware response engine 170 stores the most recent version of each piece of versioned metadata in a memory (e.g., the memory 116, the memory 108). When the streaming-aware response engine 170 generates a response that is associated with a live event, the streaming-aware response engine 170 attaches the stored, up-to-date version of each piece of versioned metadata that is associated with that live event to the response.

The streaming-aware response engine 170 can attach an up-to-date version of a piece of versioned metadata to a response in any technically feasible fashion. For instance, in some embodiments, the streaming-aware response engine 170 attaches up-to-date versions of any number of pieces of versioned metadata to a response via one or more customized headers that are included in the response.

The origin application 140, the CDN 180, and the user devices 190 can implement any number and/or types of communication protocols for the segment requests 182, the segment responses 184, the manifest requests 186, and the manifest responses 188. In some embodiments, the origin application 140, the CDN 180, and the user devices 190 implement a Hypertext Transfer Protocol (HTTP). Accordingly, each of the segment requests 182 and each of the manifest requests 186 is an HTTP request. Each of the segment responses 184 and each of the manifest responses 188 is an HTTP response.

For explanatory purposes, a resource (e.g., a segment, a manifest) requested via an HTTP request is also referred to herein as a “requested resource” with reference to both the HTTP request and a corresponding HTTP response. An HTTP request can identify a requested resource in any technically feasible fashion. In some embodiments, upon receiving an HTTP request, the origin application 140 generates a corresponding HTTP response that indicates an HTTP response code, optionally indicates a TTL, and optionally includes the requested resource.

In some embodiments, the origin application 140 includes one of the following HTTP response codes in an HTTP response: 200 “OK,” 404 “not found,” 410 “gone,” and “503 “service unavailable.” The HTTP response code 200 “OK” indicates that a corresponding HTTP request succeeded. The HTTP response code 404 “not found” indicates that a requested resource cannot be found. The HTTP response code 410 “gone” indicates that a requested resource is unavailable and that this condition is likely to be permanent. The HTTP response code 503 “service unavailable” indicates that a server (e.g., the origin server 110) is not ready to handle the corresponding HTTP request.

The origin application 140 can indicate a TTL in an HTTP response in any technically feasible fashion. In some embodiments, the origin application 140 includes an “Expires” header in an HTTP response to indicate a TTL. In some other embodiments, the origin application 140 includes a “Cache-Control” header specifying a “max age” directive in an HTTP response to indicate a TTL. A max age directive in a Cache-Control header is also commonly referred to as “Cache-Control: max-age.” As persons skilled in the art will recognize, an Expires header indicates a TTL via an expiration date (e.g., in GMT), while Cache-Control: max-age indicates a TTL via an expiration age (e.g., an integer number of seconds).

Please note that the techniques described herein are illustrative rather than restrictive and can be altered without departing from the broader spirit and scope of the embodiments. Many modifications and variations on the functionality of the origin application 140, the intake process 160, the streaming-aware response engine 170, the orchestrator 120, the streaming pipeline 130, the CDN 180, and the user devices 190 as described herein will be apparent to those of ordinary skill in the art without departing from the scope and spirit of the described embodiments.

It will be apparent to one skilled in the art that the inventive concepts may be practiced without one or more of these specific details. For instance, in some alternate embodiments, the origin application 140 does not indicate a TTL in any manifest response. In the same or other alternate embodiments, the origin application 140 does not take into account a current index when determining whether to reject a segment request.

In some alternate embodiments, the origin application 140 generates any number and/or types of manifests associated with any number of live events in any technically feasible fashion based, at least in part, on segments received from one or more streaming pipelines and any amount of publishing metadata received from the orchestrator 120. In the same or other embodiments, the origin application 140 does not receive any manifests from the streaming pipeline 130.

Similarly, the storage, organization, amount, and/or types of data described herein are illustrative rather than restrictive and can be altered without departing from the broader spirit and scope of the embodiments. In that regard, many modifications and variations on the publishing metadata, the event configuration dataset 150, the segments 132, the manifests 134, the segment requests 182, the segment responses 184, the manifest requests 186, and the manifest responses 188 as described herein will be apparent to those of ordinary skill in the art without departing from the scope and spirit of the described embodiments.

It will be appreciated that the system 100 shown herein is illustrative and that variations and modifications are possible. For example, the functionality provided by the origin application 140, the intake process 160, the streaming-aware response engine 170, the orchestrator 120, the streaming pipeline 130, the CDN 180, and the user devices 190 as described herein can be integrated into or distributed across any number of software applications (including one), and any number of components of the system 100. Further, the connection topology between the various units in FIG. 1 can be modified as desired.

### Providing Re-request and Caching Guidance

FIG. 2 is a more detailed illustration of the streaming-aware response engine 170 of FIG. 1, according to various embodiments. As described previously herein in conjunction with FIG. 1, in some embodiments, the streaming-aware response engine 170 generates responses to requests for segments and manifests associated with a live event based, at least in part, on the event configuration dataset 150 associated the live event and resources (e.g., segments, manifests) associated with the live event that are stored in the memory 108.

As shown, in some embodiments, the event configuration dataset 150 includes, without limitation, the event ID 142, the segment duration 144, the start time 152, the start index 154, the current index 156, and the end time 158. The event ID 142, the segment duration 144, the start time 152, the start index 154, the current index 156, and the end time 158 are described previously herein in conjunction with FIG. 1.

For explanatory purposes, the functionality of the streaming-aware response engine 170 is described in conjunction with a request 210 and a response 290 that are, respectively, an HTTP request and an HTTP response associated with the live event. Notably, the request 210 can be a first request from a requesting device (e.g., the CDN 180 or one of the user devices 190) for a resource or a re-request from the requesting device for the resource. The response 290 is a response to the request 210.

Referring back to FIG. 1, in some embodiments, the request 210 is one of the segment requests 182 or one of the manifest requests 186. In the same or other embodiments, the response 290 is one of the segment responses 184 or one of the manifest responses 188.

As shown, in some embodiments, the streaming-aware response engine 170 includes, without limitation, a response generator 220, a rejection TTL 226, an estimated availability time 260, an error code 270, a retry TTL 280, and a manifest TTL 240. As described in greater detail below, the streaming-aware response engine 170 optionally and independently determines any number (including none) of the rejection TTL 226, the estimated availability time 260, the error code 270, the retry TTL 280, and the manifest TTL 240 in order to generate the request 210.

As shown, in response to receiving the request 210 from the requesting device, the response generator 220 generates the response 290 based on the event configuration dataset 150 and optionally the memory 108 and then transmits the response 290 to the requesting device. Referring back to FIG. 1, in some embodiments, the requesting device is a server included in the CDN 180. In some alternate embodiments, the requesting device is a user device.

As shown, the response generator 220 includes, without limitation, a request traffic metric 222 and a DVR flag 224. The request traffic metric 222 can be any type of measurement associated with the amount of request traffic received by the origin server 110. Upon receiving the request 210, the response generator 220 determines whether the request 210 is a request for a segment associated with the live event or a request for a manifest associated with the live event.

If the request 210 is a request for a segment, then the response generator 220 determines whether the origin server 110 is overloaded based on the request traffic metric 222 in any technically feasible fashion. Notably, in some embodiments, the origin server 110 determines that the origin server 110 is overloaded when the origin server 110 is still able to service additional requests based on a configured amount of serving capacity that is reserved for servicing non-DVR requests. In some other embodiments, the response generator 220 can determine whether the origin server 110 is overloaded in any technically feasible fashion based on any number and/or types of metrics.

If the response generator 220 determines that the origin server is overloaded, then the response generator 220 determines the DVR flag 224 based on an index associated with the requested segment and the current index 156. The DVR flag 224 indicates whether the request 210 is a DVR request. The response generator 220 can determine the DVR flag 224 in any technically feasible fashion.

In some embodiments, if the index associated with the requested segment precedes the current index 156 with respect to the playback timeline associated with the live event by more than a DVR threshold (not shown), then the response generator 220 sets the DVR flag 224 to true. Setting the DVR flag 224 to true indicates that the request 210 is a DVR request. Otherwise, the response generator 220 sets the DVR flag 224 to false. Setting the DVR flag 224 to false indicates that the request 210 is not a DVR request. The DVR threshold can specify any number of segments or any amount of playback time in any technically feasible fashion.

If the origin server is overloaded and the DVR flag 224 is true, then the response generator 220 designates the request 210 as an “overloaded DVR request” and elects to reject the request 210. To reject the request 210 the response generator 220 generates and transmits to the requesting device the response 290 indicating both that a service is unavailable (e.g., via the HTTP response code 503) and the rejection TTL 226. The rejection TTL 226 indicates a new time (e.g., several seconds from a current time as per the origin clock) to re-request the requested segment.

If the request 210 is a segment request and is not designated as an overloaded DVR request, then the response generator 220 determines whether the requested segment is expected to be stored in the memory 108 based on an index associated with the requested segment. In some embodiments, to determine whether the requested segment is expected to be stored in the memory 108, the response generator 220 compares the index associated with the requested segment to a range of indices that starts at the start index 154 and ends at the current index 156.

If the index associated with the requested segment is within the range of indices, then the response generator 220 attempts to retrieve the requested segment from the memory 108. If the response generator 220 successfully retrieves the requested segment from the memory 108, then the response generator 220 generates and transmits to the requesting device the response 290 that includes the requested segment and indicates that the corresponding request succeeded (e.g., via the HTTP response code 200).

If, however, the response generator 220 fails to retrieve the requested segment from the memory 108, then the response generator 220 computes the estimated availability time 260 for the requested segment. More precisely, the response generator 220 computes the estimated availability time 260 based on the segment duration 144, the current index 156, an index associated with the requested segment, and a current time as per the origin clock.

In some alternate embodiments, the estimated availability time 260 is based on the segment duration 144, an index associated with the requested segment, a current time as per the origin clock, and the time and index of a reference segment. The reference segment is often the first segment associated with the live event that is received by the origin application 140, and therefore the time and index of the reference segment are, respectively, the start time 152 and the start index 154. The response generator 220 can determine when each segment associated with the live event is expected to arrive based on the segment duration 144, the index associated with the requested segment, the current time as per the origin clock, and the time and index of the reference signal irrespective of any delays in the generation of any segments and/or the delivery of any segments to the origin server 110.

As shown, after computing the estimated availability time 260, the response generator 220 determines the error code 270 based on the estimated availability time 260. If the estimated availability time 260 indicates that the requested segment is too late to fulfill based on a retry window (not shown) associated with the streaming pipeline 130, then the response generator 220 sets the error code 270 equal to HTTP response code 410. As described previously herein in conjunction with FIG. 1, the HTTP response code 410 indicates that the requested resource is unavailable and that this condition is likely to be permanent. The response generator 220 then generates and transmits to the requesting device the response 290 indicating the error code 270.

As used herein, a segment that is “too late” to fulfill is never generated or is generated too late for live consumption and is therefore designated as a “missing” segment. Any number and/or types of encoding or other issues can result in any number of missing segments. For explanatory purposes, a missing segment is also referred to herein as a “non-existent segment.”

Advantageously, indicating via the response 290 that a requested segment is unavailable discourages user devices from re-requesting the requested segment and can therefore reduce the number of re-requests for missing segments. Furthermore, in some embodiments, the user devices 190 can implement any number and/or types of error concealment techniques based on an indication that a requested segment is unavailable.

If the estimated availability time 260 does not indicate that the requested segment is too late, then the response generator 220 sets the error code 270 equal to HTTP response code 404. As described previously herein in conjunction with FIG. 1, HTTP response code 404 indicates that the requested resource cannot be found. The response generator 220 sets the retry TTL 280 to reflect the estimated availability time 260. The response generator 220 then generates and transmits to the requesting device the response 290 indicating the error code 270 and the retry TTL 280.

The response generator 220 can determine the retry TTL 280 in any technically feasible fashion. For instance, in some embodiments, if the estimated availability time is negative (e.g., when the current index is within the range of indices), then the response generator 220 sets the retry TTL 280 to a relatively short value. In the same or other embodiments, the response generator 220 sets the retry TTL 280 to indicate the estimated availability time 260. In some other embodiments, the response generator 220 computes a delta between the estimated availability time 260 and a current time as per the origin clock. If the delta is less than a lower threshold (e.g., five seconds), then the response generator 220 sets the retry TTL 280 equal to a relatively low value (e.g., one second) that is less than the lower threshold. If the delta is greater than or equal to the lower threshold and less than a middle threshold (e.g., thirty seconds), then the response generator 220 sets the retry TTL 280 equal to the lower threshold. If the delta is greater than or equal to the middle threshold and less than an upper threshold (e.g., five minutes), then the response generator 220 sets the retry TTL 280 equal to the middle threshold. If the delta is greater than or equal to the upper threshold, then the response generator 220 sets the retry TTL 280 equal to the upper threshold.

If the index associated with the requested segment is higher than the current index 156, then the response generator 220 computes the estimated availability time 260 as described previously herein. The response generator 220 sets the error code 270 equal to HTTP response code 404. As described previously herein, the response generator 220 sets the retry TTL 280 to reflect the estimated availability time 260. The response generator 220 then generates and transmits to the requesting device the response 290 indicating the error code 270 and the retry TTL 280.

If the index associated with the requested segment is lower than the start index 154, then the response generator 220 generates and transmits to the requesting device the response 290 indicating the HTTP response code 410.

Upon receiving the request 210, if the response generator 220 determines that the request 210 is a manifest request, then the response generator 220 determines the manifest TTL 240 based on whether streaming of the live-event is on-going. The response generator 220 can determine whether streaming of the live event is on-going in any technically feasible fashion.

For instance, in some embodiments, the response generator 220 determines that streaming of the live event is on-going until an end marker associated with the live event is received from the orchestrator 120. If streaming of the live event is on-going, then the response generator 220 sets the manifest TTL 240 to a relatively short value (e.g., half the segment duration 144). Otherwise, the response generator 220 sets the manifest TTL 240 to a relatively long value (e.g., seven days).

The response generator 220 attempts to retrieve the requested manifest from the memory 108. If the response generator 220 successfully retrieves the requested manifest from the memory 108, then the response generator 220 transmits to the requesting device a response that includes the manifest and indicates the manifest TTL 240. If the streaming-aware response engine 170 fails to retrieve the manifest from the memory 108, then the streaming-aware response engine 170 transmits to the requesting device a response indicating an error condition (e.g., the manifest cannot be found) and optionally indicating a relatively short TTL.

Please note that the techniques described herein are illustrative rather than restrictive and can be altered without departing from the broader spirit and scope of the embodiments. Many modifications and variations on the functionality of the streaming-aware response engine 170 and the response generator 220 as described herein will be apparent to those of ordinary skill in the art without departing from the scope and spirit of the described embodiments.

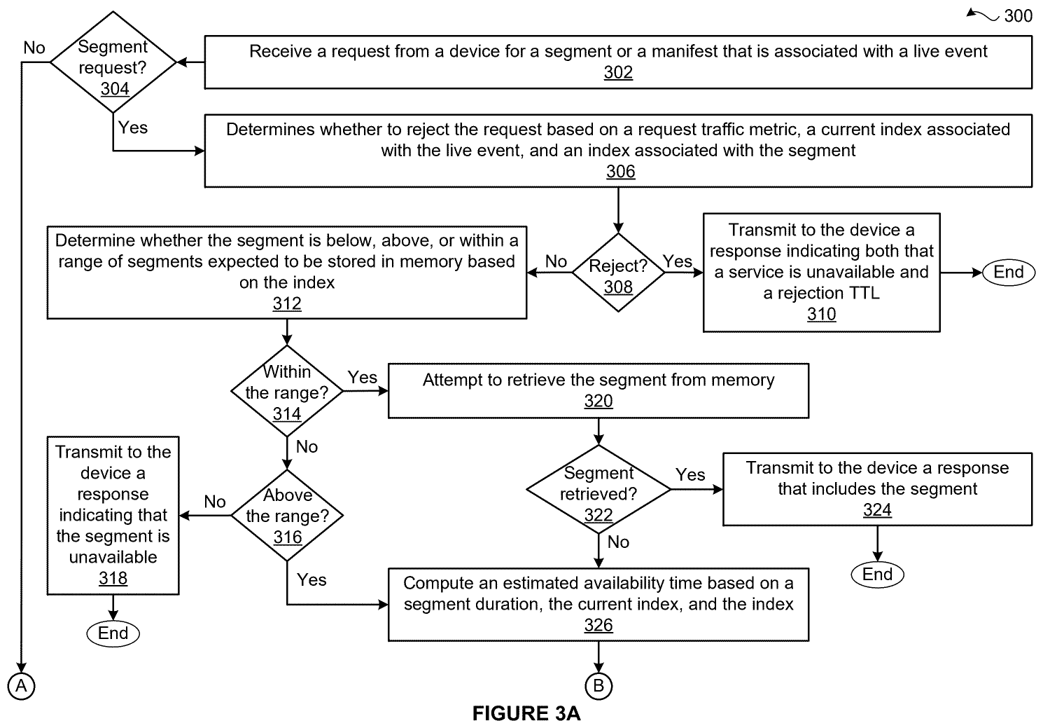

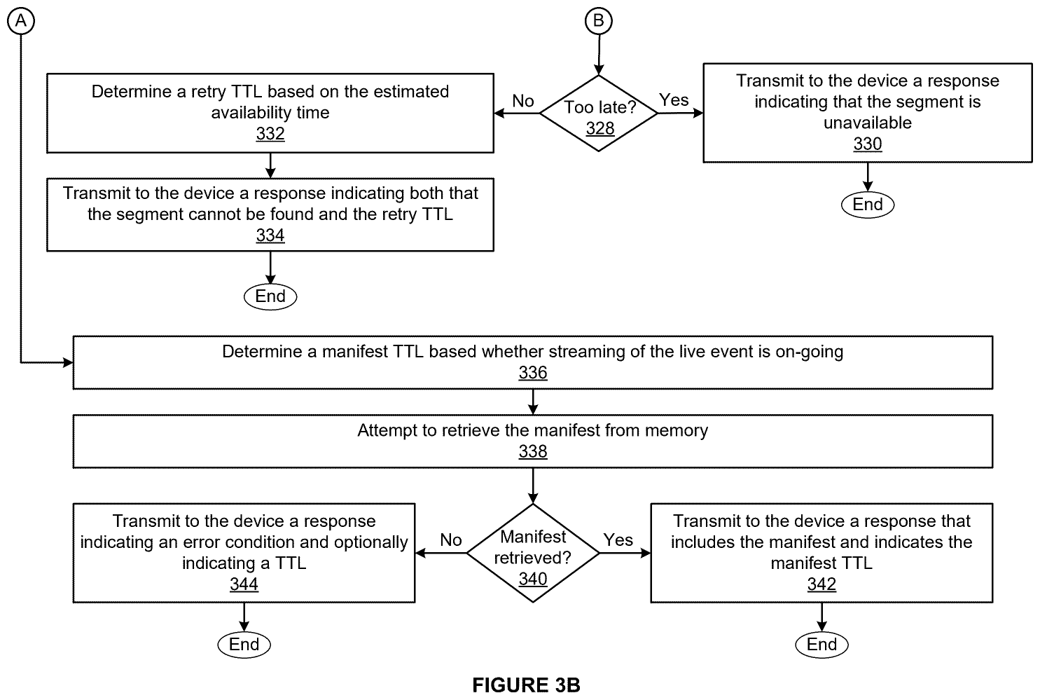

FIGS. 3A-3B set forth a flow diagram of method steps for responding to a request associated with a streamed live event, according to various embodiments. Although the method steps are described with reference to the systems of FIGS. 1-2, persons skilled in the art will understand that any system configured to implement the method steps, in any order, falls within the scope of the embodiments.

As shown, a method 300 begins at step 302, where the streaming-aware response engine 170 receives a request from a device for a segment or a manifest that is associated with a live event. In some embodiments, the device is a user device or a server in a CDN. At step 304, the streaming-aware response engine 170 determines whether the request is a segment request. If, at step 304, the streaming-aware response engine 170 determines that the request is a segment request, then the method 300 proceeds to step 306.

At step 306, the streaming-aware response engine 170 determines whether to reject the request based on request traffic metric 222, a current index associated with the live event, and an index associated with the segment. At step 308, the streaming-aware response engine 170 elects whether to reject the request. If, at step 308, the streaming-aware response engine 170 elects to reject the request, then the method 300 proceeds to step 310. At step 310, the streaming-aware response engine 170 transmits to the device a response indicating both that a service is unavailable and rejection TTL 226. The method 300 then terminates.

If, however, at step 308, the streaming-aware response engine 170 does not elect to reject the request, then the method 300 proceeds directly to step 312. At step 312, the streaming-aware response engine 170 determines whether the segment is below, above, or within a range of segments expected to be stored in memory 108 based on the index.

At step 314, the streaming-aware response engine 170 determines whether the segment is within the range of segments. If, at step 314, the streaming-aware response engine 170 determines that the segment is not within the range of segments, then the method 300 proceeds to step 316.

At step 316, the streaming-aware response engine 170 determines whether the segment is above the range of segments. If, at step 316, the streaming-aware response engine 170 determines that the segment is not above the range of segments, then the method 300 proceeds to step 318. At step 318, the streaming-aware response engine 170 transmits to the device a response indicating that the segment is unavailable and that this condition is likely to be permanent. The method 300 then terminates.

If, however, at step 316, the streaming-aware response engine 170 determines that the segment is above the range of segments, then the method 300 proceeds directly to step 326.

Referring back to step 314, if at step 314, the streaming-aware response engine 170 determines that the segment is within the range of segments, then the method 300 proceeds directly to step 320. At step 320, the streaming-aware response engine 170 attempts to retrieve the segment from memory 108. At step 322, the streaming-aware response engine 170 determines whether the segment was retrieved.

If, at step 322, the streaming-aware response engine 170 determines that the segment was retrieved, then the streaming-aware response engine proceeds to step 324. At step 324. the streaming-aware response engine 170 transmits to the device a response that includes the segment. The method 300 then terminates.

If, however, at step 322, the streaming-aware response engine 170 determines that the segment was not retrieved, then the method 300 proceeds directly to step 326.

At step 326, the streaming-aware response engine 170 computes estimated availability time 260 based on a segment duration associated with the live event, the current index, and the index associated with the requested segment. At step 328, the streaming-aware response engine 170 determines whether the requested segment is too late to fulfill based on the estimated availability time 260.

If, at step 328, the streaming-aware response engine 170 determines that the requested segment is too late to fulfill, then the method 300 proceeds to step 330. At step 330, the streaming-aware response engine 170 transmits to the device a response indicating that the segment is unavailable and that this condition is likely to be permanent. The method 300 then terminates.

If, however, at step 328, the streaming-aware response engine 170 determines that the requested segment is not too late to fulfill, then the method 300 proceeds directly to step 332. At step 332, the streaming-aware response engine 170 determines retry TTL 280 based on the estimated availability time 260. At step 334, the streaming-aware response engine 170 transmits to the device a response indicating both that the segment cannot be found and the retry TTL 280. The method 300 then terminates.

Referring back to step 304, if at step 304, the streaming-aware response engine 170 determines that the request is not a segment request, then the method 300 proceeds directly to step 336. At step 336, the streaming-aware response engine 170 determines manifest TTL 240 based on whether streaming of the live event is on-going. At step 338, the streaming-aware response engine 170 attempts to retrieve the manifest from memory 108.

At step 340, the streaming-aware response engine 170 determines whether the manifest was retrieved. If, at step 340, the streaming-aware response engine 170 determines that the manifest was retrieved, then the streaming-aware response engine 170 proceeds to step 342. At step 342, the streaming-aware response engine 170 transmits to the device a response that includes the manifest and indicates the manifest TTL 240. The method 300 then terminates.

If, however, at step 340, the streaming-aware response engine 170 determines that the manifest was not retrieved, then the method 300 proceeds directly to step 344. At step 344, the streaming-aware response engine 170 transmits to the device a response indicating an error condition and optionally indicating a TTL. The method 300 then terminates.

As persons skilled in the art will recognize, the method steps of FIG. 3 can be performed concurrently, sequentially, or any combination thereof to respond to any number of requests for any number of segments of any number of streams and/or any number of manifests associated with any number of live events.

In sum, the disclosed techniques can be used to respond to requests for segments and manifests associated with live events. In some embodiments, a system includes a streaming pipeline, an origin server, a memory, an orchestrator, a CDN, and any number of user devices. Throughout a live event, the streaming pipeline generates segments and manifests based on one or more live media feeds associated with the live event and transmits the segments and the manifests to the origin server. The origin server executes an origin application that stores received segments and manifests in the memory. Prior to the start of the live event, the orchestrator transmits a segment duration for the live event to the origin application.

When streaming of the live event starts, the origin application detects a start time for the live event, determines a start index, and sets a current index equal to the start index. As the origin application receives from the streaming pipeline segments associated with the live event, the origin application updates the current index to reflect the received segment associated with the live event that corresponds to a most recent portion of time in a timeline associated with the live event. Also throughout the live event, the origin application delivers, on-demand, segments and manifests associated with any number of live events to user devices via the CDN.

Upon receiving a request from the CDN for a segment associated with the live event, the origin application determines whether to reject the request based on a request traffic metric, the current index associated with the live event, and an index associated with the segment. If the origin application determines to reject the request, then the origin application generates and transmits to the CDN a response indicating both that a service is unavailable and a rejection TTL (e.g., a few seconds). The rejection TTL indicates a new time to re-request the segment.

Otherwise, if the index associated with the segment is less than the start index, then the origin application transmits to the CDN a response indicating that the segment is unavailable and that this condition is likely to be permanent. If, however, the index associated with the segment is greater than the current index, then the origin application computes an estimated availability time for the segment based on the segment duration, the current index, and the index associated with the segment. The origin application determines a retry TTL based on the estimated availability time and transmits to the CDN a response specifying both that the segment cannot be found and the retry TTL.

If, however, the index associated with the segment is greater than or equal to the start index and less than or equal to the current index, then the origin application attempts to retrieve the segment from the memory. If the origin application successfully retrieves the segment from the memory, then the origin application transmits to the CDN a response that includes the segment. If the origin application fails to retrieve the segment from the memory, then the origin application computes an estimated availability time for the segment based on the segment duration, the current index, and the index associated with the segment. If the estimated availability time indicates that the requested segment is too late to fulfill based on a retry window associated with the streaming pipeline, then the origin application transmits to the CDN a response indicating that the segment is unavailable. Otherwise, the origin application determines a retry TTL based on the estimated availability time and transmits to the CDN a response specifying both that the segment cannot be found and the retry TTL.

Upon receiving a request from the CDN for a manifest associated with the live event, the origin application determines a manifest TTL based on whether streaming of the live event is on-going. More specifically, if the live event has ended, then the origin application sets the manifest TTL to a relatively long value (e.g., seven days).

Otherwise, the origin application sets the manifest TTL to a relatively short value (e.g., half the segment duration). The origin application attempts to retrieve the manifest from the memory. If the origin application successfully retrieves the manifest from the memory, then the origin application transmits to the CDN a response that includes the manifest and indicates the manifest TTL. If the origin application fails to retrieve the manifest from the memory, then the origin application transmits to the CDN a response indicating an error condition (e.g., the manifest cannot be found) and optionally indicating the manifest TTL.

At least one technical advantage of the disclosed techniques relative to the prior art is that, with the disclosed techniques, the number of re-requests for the segments of a live event stream can be reduced. In that regard, with the disclosed techniques, an origin server can include, in a response to a premature request for a segment of a stream, a time-to-live (TTL) indication that reflects an estimated availability time for that segment. A CDN automatically caches the response for the period of time specified via the TTL, and any user devices that prematurely request the segment can use the TTL to delay re-requesting the segment until the estimated availability time. Because the disclosed techniques can reduce the number of re-requests for segments, the amount of network and processing resources used to stream live events can be reduced relative to what is typically required using prior art techniques. These technical advantages provide one or more technological advancements over prior art approaches.
1. In some embodiments, a computer-implemented method for responding to requests associated with streamed live events comprises receiving a first request from a first device for a first segment of a first stream associated with a live event; determining at least one of an error condition or a first time-to-live (TTL) based on a current index associated with the live event and a first index associated with the first segment; and transmitting to the first device a first response indicating at least one of the error condition or the first TTL.
2. The computer-implemented method of clause 1, further comprising failing to retrieve the first segment from a memory prior to determining the at least one of the error condition or the first TTL.
3. The computer-implemented method of clauses 1 or 2, wherein the error condition indicates that the first segment cannot be found, and the first TTL reflects an estimated availability time for the first segment.
4. The computer-implemented method of any of clauses 1-3, wherein determining the at least one of the error condition or the first TTL comprises computing an estimated availability time for the first segment based on the current index and a segment duration associated with the live event.
5. The computer-implemented method of any of clauses 1-4, wherein the error condition indicates that the first segment is unavailable.
6. The computer-implemented method of any of clauses 1-5, wherein determining the at least one of the error condition or the first TTL comprises electing to reject the first request based on a request traffic metric, the current index, and the first index; and setting the first TTL to indicate a new time to re-request the first segment.
7. The computer-implemented method of any of clauses 1-6, further comprising receiving a second request from the first device for a manifest associated with the live event; and transmitting to the first device a second response that includes the manifest and indicates a second TTL.
8. The computer-implemented method of any of clauses 1-7, further comprising determining the second TTL based on whether streaming of the live event is on-going.
9. The computer-implemented method of any of clauses 1-8, further comprising attaching an up-to-date version of a first piece of metadata that is associated with both the live event and a version identifier to the first response prior to transmitting to the first device the first response.
10. The computer-implemented method of any of clauses 1-9, further comprising receiving a re-request from the first device for the first segment at a first point-in-time that is subsequent to a second point-in-time specified via the first TTL; and transmitting to the first device a second response that includes the first segment.
11. The computer-implemented method of any of clauses 1-10, further comprising attaching an up-to-date version of a first piece of metadata that is associated with both the live event and a version identifier to the second response prior to transmitting to the first device the second response.
12. The computer-implemented method of any of clauses 1-11, wherein the first device comprises a user device or a server included in a content delivery network.
13. In some embodiments, one or more non-transitory computer readable media include instructions that, when executed by one or more processors, cause the one or more processors to respond to requests associated with streamed live events by performing the steps of receiving a first request from a first device for a first segment of a first stream associated with a live event; determining at least one of an error condition or a first time-to-live (TTL) based on a current index associated with the live event and a first index associated with the first segment; and transmitting to the first device a first response indicating at least one of the error condition or the first TTL.
14. The one or more non-transitory computer readable media of clause 13, further comprising failing to retrieve the first segment from a memory prior to determining the at least one of the error condition or the first TTL.
15. The one or more non-transitory computer readable media of clauses 13 or 14, wherein the error condition indicates that the first segment cannot be found, and the first TTL reflects an estimated availability time for the first segment.
16. The one or more non-transitory computer readable media of any of clauses 13-15, wherein determining the at least one of the error condition or the first TTL comprises computing an estimated availability time for the first segment based on the current index, the first index, and a segment duration associated with the live event.
17. The one or more non-transitory computer readable media of any of clauses 13-16, wherein determining the at least one of the error condition or the first TTL comprises determining that the first segment is unavailable based on the first index and the current index.
18. The one or more non-transitory computer readable media of any of clauses 13-17, wherein the error condition indicates that a service is unavailable, and the first TTL indicates a new time to re-request the first segment.
19. The one or more non-transitory computer readable media of any of clauses 13-18, further comprising receiving a second request from the first device for a manifest associated with the live event; and transmitting to the first device a second response indicating both that the manifest cannot be found and a second TTL.
20. The one or more non-transitory computer readable media of any of clauses 13-19, further comprising receiving a re-request from the first device for the first segment at a point-in-time that is subsequent to the first TTL; and transmitting to the first device a second response that includes the first segment.
21. The one or more non-transitory computer readable media of any of clauses 13-20, wherein the first device comprises a user device or a server included in a content delivery network.
22. In some embodiments, a system comprises one or more memories storing instructions and one or more processors coupled to the one or more memories that, when executing the instructions, perform the steps of receiving a first request from a first device for a first segment of a first stream associated with a live event; determining at least one of an error condition or a first time-to-live (TTL) based on a current index associated with the live event and a first index associated with the first segment; and transmitting to the first device a first response indicating at least one of the error condition or the first TTL.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. In the context of this document, a computer readable storage medium may be any tangible medium that can contain, or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory, Flash memory, an optical fiber, a portable compact disc read-only memory, an optical storage device, a magnetic storage device, or any suitable combination of the foregoing.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for responding to requests associated with streamed live events, the method comprising:
receiving a first request from a first device for a first segment of a first stream associated with a live event;
determining at least one of an error condition or a first time-to-live (TTL) based on a current index associated with the live event and a first index associated with the first segment; and
transmitting to the first device a first response indicating at least one of the error condition or the first TTL.

2. The computer-implemented method of claim 1, further comprising failing to retrieve the first segment from a memory prior to determining the at least one of the error condition or the first TTL.

3. The computer-implemented method of claim 1, wherein the error condition indicates that the first segment cannot be found, and the first TTL reflects an estimated availability time for the first segment.

4. The computer-implemented method of claim 1, wherein determining the at least one of the error condition or the first TTL comprises computing an estimated availability time for the first segment based on the current index and a segment duration associated with the live event.

5. The computer-implemented method of claim 1, wherein the error condition indicates that the first segment is unavailable.

6. The computer-implemented method of claim 1, wherein determining the at least one of the error condition or the first TTL comprises:
electing to reject the first request based on a request traffic metric, the current index, and the first index; and
setting the first TTL to indicate a new time to re-request the first segment.

7. The computer-implemented method of claim 1, further comprising:
receiving a second request from the first device for a manifest associated with the live event; and
transmitting to the first device a second response that includes the manifest and indicates a second TTL.

8. The computer-implemented method of claim 7, further comprising determining the second TTL based on whether streaming of the live event is on-going.

9. The computer-implemented method of claim 1, further comprising attaching an up-to-date version of a first piece of metadata that is associated with both the live event and a version identifier to the first response prior to transmitting to the first device the first response.

10. The computer-implemented method of claim 1, further comprising:
receiving a re-request from the first device for the first segment at a first point-in-time that is subsequent to a second point-in-time specified via the first TTL; and
transmitting to the first device a second response that includes the first segment.

11. The computer-implemented method of claim 10, further comprising attaching an up-to-date version of a first piece of metadata that is associated with both the live event and a version identifier to the second response prior to transmitting to the first device the second response.

12. The computer-implemented method of claim 1, wherein the first device comprises a user device or a server included in a content delivery network.

13. One or more non-transitory computer readable media including instructions that, when executed by one or more processors, cause the one or more processors to respond to requests associated with streamed live events by performing the steps of:
receiving a first request from a first device for a first segment of a first stream associated with a live event;
determining at least one of an error condition or a first time-to-live (TTL) based on a current index associated with the live event and a first index associated with the first segment; and
transmitting to the first device a first response indicating at least one of the error condition or the first TTL.

14. The one or more non-transitory computer readable media of claim 13, further comprising failing to retrieve the first segment from a memory prior to determining the at least one of the error condition or the first TTL.

15. The one or more non-transitory computer readable media of claim 13, wherein the error condition indicates that the first segment cannot be found, and the first TTL reflects an estimated availability time for the first segment.

16. The one or more non-transitory computer readable media of claim 13, wherein determining the at least one of the error condition or the first TTL comprises computing an estimated availability time for the first segment based on the current index, the first index, and a segment duration associated with the live event.

17. The one or more non-transitory computer readable media of claim 13, wherein determining the at least one of the error condition or the first TTL comprises determining that the first segment is unavailable based on the first index and the current index.

18. The one or more non-transitory computer readable media of claim 13, wherein the error condition indicates that a service is unavailable, and the first TTL indicates a new time to re-request the first segment.

19. The one or more non-transitory computer readable media of claim 13, further comprising:
receiving a second request from the first device for a manifest associated with the live event; and
transmitting to the first device a second response indicating both that the manifest cannot be found and a second TTL.

20. The one or more non-transitory computer readable media of claim 13, further comprising:
receiving a re-request from the first device for the first segment at a point-in-time that is subsequent to the first TTL; and
transmitting to the first device a second response that includes the first segment.

21. The one or more non-transitory computer readable media of claim 13, wherein the first device comprises a user device or a server included in a content delivery network.

22. A system comprising:
one or more memories storing instructions; and
one or more processors coupled to the one or more memories that, when executing the instructions, perform the steps of:
receiving a first request from a first device for a first segment of a first stream associated with a live event;
determining at least one of an error condition or a first time-to-live (TTL) based on a current index associated with the live event and a first index associated with the first segment; and
transmitting to the first device a first response indicating at least one of the error condition or the first TTL.
